(19) United States
(12) Patent Application Publication
(10) Pub. No.: US 2013/0256605 A1
(43) Pub. Date: Oct. 3, 2013

(54) COMPOSITES HAVING HIGH LEVELS OF CARBON NANOTUBES AND A PROCESS FOR THEIR PRODUCTION

(71) Applicants: Usama E. Younes, McMurray, PA (US); Serkan Unal, Istanbul (TR); Eric Giles, Pittsburgh, PA (US); Joel Matsco, Coraopolis, PA (US)

(72) Inventors: Usama E. Younes, McMurray, PA (US); Robert N. Hunt, Steubenville, OH (US); Serkan Unal, Istanbul (TR); Eric Giles, Pittsburgh, PA (US); Joel Matsco, Coraopolis, PA (US)

(73) Assignee: Bayer MaterialScience LLC, Pittsburgh, PA (US)

(21) Appl. No.: 13/433,685

(22) Filed: Mar. 29, 2012

(51) Int. Cl. H01B 1/04

(52) U.S. Cl. CPC H01B 1/04; Y10S 977/752; Y10S 977/90; B82Y 30/00
USPC 252/511; 427/385.5; 427/389.8; 427/393.5; 427/294; 427/386; 977/752; 977/900

(57) ABSTRACT

Composite materials having a multi-wall carbon nanotube content of from 4 to 15% by weight, based on total weight of the composite, are produced from a dispersion of multi-wall carbon nanotubes (MWCNTs) and a fiber reinforcing material in a carrier fluid which is processed to form a shaped article that may then be infused with a liquid polymer or polymer-forming mixture to form the composite.

### STATEMENT REGARDING FEDERALLY SPONSORED RESEARCH

This invention was made at least in part, through research funded by the U.S. Government under contract number EE-EE0001361 awarded by the U.S. Department of Energy. The government may have certain rights in the invention.

### BACKGROUND OF THE INVENTION

The present invention relates to composites reinforced with both a fibrous material and carbon nanotubes that are produced by a vacuum infusion or pultrusion process and to the process for producing such composites. The composites of the present invention are characterized by significantly higher levels of carbon nanotubes than known composites. The composites of the present invention are useful for producing large articles characterized by reduced shrinkage and improved fracture toughness. The composites of the present invention are particularly suitable for applications such as turbine wind blades.

Reinforced composites are being used for a number of applications where strength and light weight are important physical properties. Examples of applications for which fiber reinforced composites are employed include automotive components and construction materials.

The use of carbon nanotubes as a reinforcement material is problematic in that uniform dispersion of the nanotubes must be achieved in order to attain product consistency and to avoid the creation of segments within the composite product that have poorer properties than other segments of that composite product. Use of carbon nanotubes also presents the problem of the formation of agglomerates after those nanotubes have been dispersed which agglomerates will adversely affect the properties of the composite product.

To date, the applications for which composites that include both carbon nanotubes and glass fibers have been used have been limited by the inability to achieve uniform distribution of the fibrous and carbon nanotube reinforcing materials, particularly, the inability to uniformly distribute carbon nanotubes in amounts greater than 2-3%.

Methods for including particulate materials such a carbon nanotubes in polymeric composites have been developed. In U.S. Pat. No. 7,955,654, for example, multi-walled carbon nanotubes are dispersed in an organic solvent. Monomers and an initiator are then dissolved in this dispersion. The dissolved monomers are then coated on the surface of a substrate and polymerized to form a composite which is said to contain up to 10 wt. % of carbon nanotubes. However, the composites produced by this process have carbon nanotubes present at the coated surface. The carbon nanotubes are not distributed within a substrate such as glass fibers.

U.S. Pat. No. 6,936,653 discloses composite materials composed of polar polymers and single-wall carbon nanotubes characterized by electrical and/or thermal conductivity and a process for their production. In the disclosed process, single-walled carbon nanotubes are dispersed in a polar polymer in a solvent to make a nanotube-polymer suspension. The solvent is then removed from the suspension to form a nanotube-polymer composite. It is taught that this method successfully incorporates up to about 40% by weight of carbon nanotubes in the composites disclosed therein. However, the composites produced by this method do not include a fibrous reinforcing material such as glass fibers.

U.S. Pat. No. 7,838,587 discloses polymeric materials containing dispersed carbon nanotubes which are produced by incorporating the nanotubes into a mixture of a polymer and a dispersant selected from specified types of block copolymers and heating this mixture while stirring. To this mixture is added a hardener and the resulting mixture is then introduced into a mold. It is taught that the carbon nanotubes may be incorporated in these molded articles in an amount of up to 80 parts by weight. However, the composites produced by this method do not include a fibrous reinforcing material such as glass fibers.

U.S. Pat. No. 7,935,276 discloses polymeric materials which incorporate carbon nanostructures which are carbon nanospheres that are hollow, multi-walled particles having multiple graphitic layers, an outer diameter of less than 1 micron and no surface functional groups. These specialty nanospheres were developed because incorporation of carbon nanotubes into polymeric materials was found to be “very challenging”. The fibrous shape of carbon nanotubes combined with their small size makes them difficult to uniformly disperse in polymers. (column 1, lines 38-45) It is taught that these specialty nanospheres may be incorporated into composites in amounts of up to about 70% by weight. It is also taught that these specialty nanospheres may be used in combination with fillers or dispersing agents. However, there is no teaching that these specialty nanospheres can be used in combination with a fibrous reinforcing material such as glass fibers in any amount.

Published U.S. Patent Application 2011/0086956 discloses nanocomposite master batch compositions and a method for producing polymeric nanocomposite materials in which polymer nanocomposites are made by dissolving a polymer in a solvent to produce a polymer solution. A dispersing aid (e.g., a surfactant or compatibilizing agent) is added to this polymer solution and a filler material is then added to produce a dissolved polymer intimately mixed with the nanocomposite material. This mixture is then treated (e.g., by addition of a non-solvent liquid) to cause the precipitation of the dissolved composite solution to produce a nanocomposite master batch. This nanocomposite master batch may then be used'in its highly concentrated state or further compounded with additional polymer material. It is taught that the amount of carbon nanotubes which may be incorporated into the masterbatch is up to 60% by weight. This disclosed process is, however, limited to polymers that can be dissolved in a solvent.

Published U.S. Patent Application 2011/0171364 discloses a process for the production of carbon nanotube-based pastes in which carbon nanotubes are milled to disperse them in a liquid to form the paste. Such nanotube-containing pastes are then used to produce battery electrodes. The pastes disclosed in this publication do not, however, include a fibrous reinforcing material and would not therefore be suitable for the production of large molded articles.

Published U.S. Patent Application 2011/0245378 discloses nanomaterial-reinforced compositions and methods for their production and use. In the processes disclosed in this publication, carbon nanotubes are dispersed in a resin by contacting the carbon nanotubes with the resin. In one embodiment of the published process, the reinforcement material (e.g., carbon nanotubes) is combined with a first solvent and then dispersed in the solvent by any of a variety of methods, including, mixing, sonication, and shaking. After being dispersed in the first solvent, the reinforcement material may be mixed with the resin which is subsequently cured. Articles produced from the described carbon nanotube dispersions do not, however, include more than 10% by weight of carbon nanotubes. There is no teaching with respect to inclusion of glass fibers.

Pending application, U.S. Ser. No. 13/400,292 filed on Feb. 20, 2012, discloses the use of vacuum infusion or pultrusion to produce a composite article reinforced with both carbon nanotubes and a fiber reinforcing agent. However, the amount of carbon nanotubes taught to be incorporable in such composites is no greater than 3% by weight.

Incorporation of more than 3% by weight of carbon nanotubes (based on the total weight of the composite) in composites that are also reinforced with a fibrous reinforcing material such as glass fibers using an polymeric binder material without the need to use specially modified carbon nanotubes has not yet been achieved.

It would, therefore, be advantageous to develop a process for uniformly dispersing carbon nanotubes in relatively large amounts in a fiber reinforced composite article and a process for producing a composite containing a relatively large amount of carbon nanotubes.

### SUMMARY OF THE INVENTION

It is an object of the present invention to provide a process for incorporating large amounts of carbon nanotubes into fiber-reinforced composite articles.

It is also an object of the present invention to provide a process for incorporating carbon nanotubes into a fibrous reinforcing material from which a composite article may be produced by, e.g., a vacuum infusion process or a pultrusion process that is not limited with respect to the polymeric binder composition.

It is another object of the present invention to provide a method for uniformly distributing up to 15% by weight of carbon nanotubes in a fibrous reinforcing material to form a substrate into which a polymeric binder may be incorporated, e.g., by a vacuum infusion process or by a pultrusion process.

It is a further object of the present invention to provide a carbon nanotube and fiber reinforced composite article in which up to 15% by weight of carbon nanotubes are uniformly dispersed.

It is also an object of the present invention to provide a carbon nanotube and fiber reinforced composite article having a carbon nanotube content of up to 15% by weight produced with a liquid epoxy resin or polyurethane-forming system.

It is another object of the present invention to provide a carbon nanotube and fiber reinforced composite suitable for use as a wind turbine blade.

It is also an object of the present invention to provide a process for vacuum infusion of a reinforcing fiber and carbon nanotube-containing substrate in which up to 15% by weight of carbon nanotubes are uniformly dispersed with a liquid polymer or polymer-forming system.

These and other objects which will be apparent to those skilled in the art are accomplished by dispersing from 2 to 30% by weight, based on weight of a carrier fluid, of the multi-wall carbon nanotubes (MWCNTs) in the carrier fluid to form a dispersion in which the MWCNTs are evenly distributed. From 6 to 25% by weight (based on total weight of MWCNT and carrier fluid) of fibrous strands are then added to the dispersion in a manner such that the dispersion is evenly distributed on the fibrous strands. Excess carrier fluid is then removed from the dispersion to form a viscous paste. The viscous paste is then formed into an article having the desired shape and dried to remove any remaining liquid. This shaped article is then infused with a polymeric binder composition. The binder composition is then cured to form a composite having a MWCNT content of from 4 to 15% by weight.

### DETAILED DESCRIPTION OF THE PRESENT INVENTION

The present invention is directed to a process of producing composite articles that are reinforced with both carbon nanotubes and a fibrous material in which up to 15% by weight of carbon nanotubes is incorporated without the need for modification of the carbon nanotubes and without limitation as to suitable polymeric binders. The present invention is also directed to the composite articles produced by this process.

More specifically, the present invention provides a process for the production of a composite material having a multi-wall carbon nanotube content of from 4 to 15% by weight, based on total weight of the composite. In this process, from 2 to 30% by weight, based on weight of carrier fluid, of the multi-wall carbon nanotubes (MWCNTs) are dispersed in a carrier fluid to form a dispersion in which the MWCNTs are evenly distributed. From 6 to 25 by weight (based on total weight of MWCNTs and carrier fluid) of fibrous strands are added to this dispersion and are mixed with the carrier fluid and MWCNTs in a manner such that the strands are evenly distributed in the dispersion. Excess carrier fluid is then removed from the dispersion to form a viscous paste. The viscous paste is then formed into an article having the desired shape, dried to remove any remaining liquid, and then infused with a polymeric binder composition. The polymeric binder composition is then cured to form the composite material having a MWCNT content of from 4 to 15% by weight.

Any of the known, commercially available carbon nanotubes may be used in the process of the present invention. Multiwall carbon nanotubes and functionalized carbon nanotubes are generally preferred for economic reasons but other types of nanotubes may also be used. Multiwall carbon nanotubes are commercially available under the names Baytubes C150 and Baytubes C70 from Bayer MaterialScience. Functionalized carbon nanotubes are those having functional groups such as amine or hydroxyl groups on their surface.

Suitable carrier fluids which may be used in the practice of the present invention include water and any of the known organic solvents which are capable of forming a dispersion containing up to 30 wt. % of the carbon nanotubes and which can be removed (e.g., by vaporization) from the dispersion to form a paste. Examples of suitable carrier fluids include: water, acetone, methanol, hexane and toluene. Water is the most preferred carrier fluid.

The carbon nanotubes are added to the carrier fluid in an amount of from 2 to 30 wt. %, based on the weight of the carrier fluid, preferably, from 2 to 20 wt. %, most preferably, from 2 to 10 wt. %.

The carbon nanotubes may be dispersed and evenly distributed throughout the carrier fluid by any suitable technique known to those skilled in the art. Examples of suitable dispersion techniques include: high shear mixing, sonication, and ball milling.

After the carbon nanotube/carrier fluid dispersion has been formed, the fibrous reinforcing material is added in an amount of from 6 to 25% by weight, based on the total weight of carbon nanotubes plus carrier fluid, preferably, from 6 to 20% by weight, most preferably, from 6 to 15% by weight.

Any fibrous material capable of being incorporated into the dispersion in the above-specified amounts may be used in the process of the present invention. It is preferred that the fibrous material have a length no greater than 0.125 inches (0.3175 cm), preferably, no greater than 0.1 inches (0.254 cm), most preferably, from 0.05 inches (0.127 cm) to 0.08 inches (0.2032 cm).

Examples of suitable fibrous reinforcing materials include: glass fibers carbon fibers, natural fibers, polyester fibers, aramid fibers, nylon fibers, basalt fibers, and combinations thereof.

After the fibers have been added to the carbon nanotube/carrier fluid dispersion, they are mixed into the dispersion in a manner such that the fibers are evenly distributed throughout the dispersion. Any of the known techniques for mixing such materials may be used. Examples of suitable techniques include: high shear mixing, sonication, and ball milling.

Excess carrier fluid present in the dispersion containing both the carbon nanotubes and the fiber reinforcing material is then removed to leave a paste containing carbon nanotubes and the fibrous reinforcing material. The solvent may be removed by any of the techniques known to those skilled in the art. Examples of suitable techniques include: evaporation freeze drying and sublimation. Evaporation is the preferred technique.

The paste remaining after excess carrier fluid has been removed will generally have a viscosity of from 50,000 centipoise to 1,000,000 centipoise, preferably, from 100,000 centipoise to 500,000 centipoise, most preferably, from 200,000 centipoise to 350,000 centipoise.

The paste remaining after removal of excess solvent preferably has a carbon nanotube content of from 2 to 30 wt. %, more preferably, from 2 to 10 wt. %, most preferably, from 3 to 6 wt. % and a reinforcing fiber content of from 15 to 30 wt. %, more preferably, from 15 to 24 wt. %, most preferably, from 14 to 22 wt. %.

The paste thus obtained is then shaped into the desired form of the composite article. Any of the known techniques for forming pastes into shaped articles may be used. Examples of suitable forming techniques include molding and hand lay-up.

After being dried to remove any remaining liquid in the paste, the shaped article is then infused with a liquid polymeric or polymer-forming binder composition.

Any liquid polymer or polymer-forming system having a viscosity of less than 2000 centipoise, preferably, less than 1,000 centipoise, most preferably, less than 600 centipoise may be infused into the shaped carbon nanotube/reinforcing fiber paste. Examples of suitable liquid polymers and polymer-forming systems that may be used in the practice of the present invention include epoxy resins, vinyl ester resins and polyurethane-forming systems. Polyurethane-forming systems and epoxy resins are particularly preferred.

Any of the known techniques for infusing a polymeric material into fibrous materials may be used to produce the composites of the present invention. Vacuum infusion and pultrusion are examples of suitable processes.

In a vacuum infusion process, the liquid polymer or polymer-forming system is infused into a fibrous reinforcing material and subsequently cured to produce an infused reinforced material.

The weight percentage of the fiber reinforcement in the composites of the present invention may range from 20 to 70 wt. %, preferably, from 30 to 50 wt. % and the weight percentage of carbon nanotubes in the composites may range from 4 to 15% by weight, preferably, from 6 to 14% by weight, most preferably, from 7 to 12% by weight.

The composites of the present invention are characterized by low electrical resistivity (less than 1000 Ohms and greater than 10¹² Ohms) and improved abrasion resistance (determined in accordance with ASTM D3489) and improved flexural strength (determined in accordance with ASTM D790). These characteristics make the composites of the present invention particularly useful for applications such as wind turbine blades.

The composites of the present invention are preferably made by a vacuum infusion process. Vacuum infusion processes are known to those skilled in the art.

In a particularly preferred embodiment of a vacuum infusion process for production of the composites of the present invention, the liquid polymer or polymer-forming binder is de-gassed. The paste containing carbon nanotubes and fibrous reinforcing material is placed in a vacuum chamber (typically, one or more bags). The pressure within this vacuum chamber is then drawn down. The pressure differential between the vacuum chamber in which the pressure has been reduced and the atmospheric pressure on the reaction mixture pushes the reaction mixture into the vacuum chamber and into the fibrous reinforcing material. The polymeric binder or polymer-forming mixture is cured and the composite thus formed is removed from the vacuum chamber.

A more detailed description of a vacuum infusion process can be found in Published U.S. Patent Applications 2008/0220112 and 2008/0237909.

Having thus described the invention, the following Examples are given as being illustrative thereof. All parts and percentages reported in these Examples are parts by weight or percentages by weight, unless otherwise indicated.

### EXAMPLES

The materials used in the Examples which follow were:
EPOXY: The reaction product of 100 parts by weight of the epoxy which is commercially available under the name Hexion Epikote 135i epoxy with 30 parts of the hardener designated Hexion Epi Kure.
MWCNT: Multiwall carbon nanotubes which are commercially available under the name Baytubes from Bayer MaterialScience LLC.
AMWCNT: Multiwall carbon nanotubes with amine functional groups prepared from MWCNT.

The procedure used to produce the composites being tested was as follows:

2 wt. % of MWCNT were dispersed in water (0.3 liters) by ultrasonic treatment. 8 wt. % of glass fiber strands (length= 1/16′) were then added to the MWCNT/water dispersion and mechanically mixed to evenly disperse those fibers throughout the dispersion. The excess water was removed from this mixture and a viscous paste having 15-30 wt. % solids resulted. The viscous paste was fabricated into a panel and was slowly dried to obtain a non-woven, self-standing network of MWCNTs and glass fiber strands. This MWCNT/glass fiber panel was then infused with EPOXY under vacuum. After curing the composite, the glass fiber content and the MWCNT content were verified using thermogravimetric analysis. The MWCNT and glass fiber dispersion quality was evaluated with a scanning electron microscope.

The composition of each composite evaluated and the results of those evaluations are reported in Table 1.

TABLE 1

| | | Flex | | Flex | Surface | |
|---|---|---|---|---|---|---|
| | | Modulus | Flex | Strength | Resistivity | |
| Example | Composition | (psi) | Strain (%) | (psi) | (Ω/□) | SEM |
| 1* | EPOXY | 445 | 6.1 | 16.8 | >10¹² | |
| 2* | EPOXY + | 738 | 2.2 | 15.2 | >10¹² | Poor |
| | 32 wt. % | | | | | adhesion |
| | glass | | | | | |
| 3¹ | EPOXY + 8 wt. % | 769 | 2.4 | 17.0 | <10³ | Good |
| | MWCNT + | | | | | Adhesion |
| | 32 wt. % | | | | | |
| | glass | | | | | |
| 4 | EPOXY + 8 wt. % | Not | Not | Not | 10³-10⁴ | Good |
| | AMWCNT + | measured | measured | measured | | Adhesion |
| | 32 wt. % | | | | | |
| | glass | | | | | |

*Comparative Example
¹Shaped mat was oven dried.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a composite material having a multi-wall carbon nanotube content of from 4 to 15% by weight, based on total weight of the composite, comprising:
a) dispersing from 2 to 30% by weight, based on weight of carrier fluid, of the multi-wall carbon nanotubes (MWCNTs) in a carrier fluid to form a dispersion in which the MWCNTs are evenly distributed,
b) adding from 6 to 25% by weight, based on total weight of MWCNT and water, of fibrous strands to the dispersion from a) to evenly distribute the strands in the dispersion,
c) removing excess carrier from the dispersion from b) to form a viscous paste,
d) forming the paste produced in c) into an article having a desired shape,
e) removing any remaining liquid from the paste,
f) infusing the article formed in d) with a polymeric binder composition, and
g) curing the binder composition to form the composite material having a MWCNT content of from 4 to 15% by weight.

2. The process of claim 1 in which the carrier fluid is selected from water and any solvent that will vaporize under process conditions.

3. The process of claim 1 in which the MWCNTs are dispersed in the carrier fluid by an ultrasonic treatment or by mechanical mixing.

4. The process of claim 1 in which glass fiber strands having a length no greater than 0.125 inches were added to the dispersion in step by

5. The process of claim 1 in which the fibrous strands are selected from the group consisting of glass fibers, carbon fibers, natural fibers, and aramid fibers.

6. The process of claim 1 in which the fibrous material is incorporated into the dispersion containing MWCNTs by mechanical mixing.

7. The process of claim 1 in which excess carrier fluid is removed from the dispersion in step c) by evaporation, freeze drying or sublimation.

8. The process of claim 1 in which the viscous paste formed in step c) has a MWCNT content of from 2 to 30% by weight.

9. The process of claim 1 in which the viscous paste formed in step c) has a solids content of from 15 to 30% by weight.

10. The process of claim 9 in which the article formed in step d) is a panel.

11. The process of claim 1 in which the article formed in step d) is a panel.

12. The process of claim 1 in which step f) is carried out by a vacuum infusion process.

13. The process of claim 1 in which step f) is carried out by vacuum infusion, hand lay-up or resin transfer molding.

14. The process of claim 1 in which the polymeric binder is selected from epoxies, polyurethanes, polyesters, and vinyl esters.

15. The process of claim 1 in which the MWCNT's are non-functionalized.

16. A composite article produced by the process of claim 1 characterized by low electrical resistivity (e.g., from >10¹² Ohms to <10³ Ohms) and improved abrasion resistance.

17. A composite article produced by the process of claim 8 characterized by higher electrical conductivity, and improved abrasion resistance.
